(19) United States
(12) Patent Application Publication
(10) Pub. No.: US 2008/0016385 A1
(43) Pub. Date: Jan. 17, 2008

(54) Plain Language Announcement of Diagnostic and Troubleshooting Information for Users

(76) Inventors: Robert E. Hollingsworth, Smithtown, NY (US); Gary E. Johnson, Austin, TX (US)

Correspondence Address: Jeffrey C. Hood;Meyertons Hood Kivlin Kowert & Goetzel PC, P.O. Box 398, Austin, TX, 78767-0398, US

(21) Appl. No.: 11/457,359

(22) Filed: Jul. 13, 2006

(51) Int. Cl. G06F 11/00

(52) U.S. Cl. 714/3

(57) ABSTRACT

System and method for providing information to a user about an electronic device. One or more diagnostic tests may be performed on the electronic device which indicate whether the electronic device is able to properly operate. Correspondingly, one or more problems may be identified with regard to the operation of the electronic device based on the one or more diagnostic tests. The problems may include configuration problems, e.g., where the user has improperly set up the electronic device and/or malfunctions, e.g., where a component has failed. Additionally, one or more speech phrases may be audibly presented to the user which indicate the problem(s). The speech phrase(s) may also indicate to the user how to solve the problem and/or what resources may be used to solve the problem. The method may also present a tutorial to the user which guides the user in configuring at least a portion of the electronic device.

### FIELD OF THE INVENTION

The present invention relates to the field of electronic diagnostics and more particularly to a system and method for providing speech phrases to users about their electronic systems.

### DESCRIPTION OF THE RELATED ART

In recent years, there has been a proliferation of electronic and computing devices. In particular, when users without any particular expertise in setting up or maintaining electronic equipment purchase a wide variety of these devices, they must often set them up without any technical help. Oftentimes, the user becomes frustrated when the device does not appear to work as advertised due to various problems, such as component malfunctions, or, more commonly, configuration errors. Configuration errors tend to occur when the user does not fully understand how to set up the electronic device, e.g., using the provided manuals and installation sheets. As a result, many of the purchased is electronic devices are returned to the manufacturer without any malfunction in the electronic device. Correspondingly, it is important that manufacturers provide adequate information regarding the electronic devices.

Currently, many electronic devices provide information to the user regarding the electronic device using various audio and visual methods. The most common example are installation manuals and technical sheets; however, in many cases, manufacturers will augment this information with indications. For example, in current computers, if there is an error on initiation, the computer may output various “beep codes” (where the computer beeps with a certain pattern or a certain number of times) which indicate where the error occurred. In these cases, the user must understand what the beeps are and what information they are communicating; in many cases, the user is not aware or able to interpret this information. Alternatively, some devices may display the problems visually on a display screen; however, this requires that the display screen be properly configured and essentially, that the electronic device mostly already work. Thus, improvements in providing information to users about electronic devices are desirable.

### SUMMARY OF THE INVENTION

Various embodiments of a system and method for presenting speech phrases regarding an electronic device are presented herein. In some embodiments, the electronic device may be a computer system, e.g., with memory mediums, processors, audio components, video components, hard drives, controller hubs, controller(s), e.g., embedded controller(s), and/or other components. Alternatively, the electronic device may be any type of electronic system as desired. In particular, the electronic system may include any of various types of electronic systems, e.g., computer systems, audio/video systems, gaming systems, handheld systems, testing systems, networking systems, appliances, and/or other electronic systems (e.g., consumer electronic systems).

As indicated above, the electronic system may include a controller, e.g., coupled to various components in the system, operable to perform various functions described herein, among others. The controller, e.g., the embedded controller, may be distributed or centralized as desired. In other words, the controller may take on any appropriate shape or distribution as required. For example, the embedded controller may be within one or more of the components already included in the electronic device/system, or may simply couple to the various components, among other arrangements.

In some embodiments, one or more diagnostic tests may be performed on an electronic device, e.g., using hardware, e.g., dedicated hardware, of the electronic device. For example, in one embodiment, the diagnostic tests may be performed by the controller, e.g., the embedded controller, in the electronic device. As also indicated above, the electronic device may be any of various appropriate electronic devices as desired. In one embodiment, the one or more diagnostic tests may indicate whether the electronic device is able to properly operate. For example, the diagnostic tests may check whether each of the components and/or parts of the electronic device is properly functioning, e.g., whether or not there is component failure. In some embodiments, the controller may perform various diagnostic tests on a subset or all of the components in the electronic device.

Additionally (or alternatively), the diagnostic tests may determine whether the user has properly configured the device, e.g., whether each of the user-configurable components or parts are properly connected or otherwise configured. For example, the diagnostic tests may determine whether various parts have been attached to the electronic device as required. More specifically, if the electronic device is an audio device, the diagnostic tests may determine whether or not various audio inputs or outputs are connected to the system, e.g., whether the speakers, another audio device (e.g., for providing input or output to the audio device), and other components/parts of the system are coupled to the electronic device. Alternatively, where the electronic device is a computer, the diagnostic tests may determine whether the keyboard and/or the mouse (among other devices) are coupled to the appropriate ports of the computer. Thus, the diagnostic tests may determine whether the electronic system should function properly for the user, e.g., by determining if all of the components are functioning properly and whether the electronic device has been properly configured, among others.

The one or more diagnostic tests may be performed upon initiation or power up of the device; alternatively, or additionally, the electronic system may receive input, e.g., from the user, to initiate the diagnostic tests. Thus, the user may wish to check to make sure if the electronic device is properly functioning (or to properly identify the problem) and may initiate the set of tests or turn on the device, among other initiation methods.

The initiation of the diagnostic tests may be simple, such that whatever implemented means for initiation may be invoked when the electronic device is substantially inoperable. Said another way, the tests may be run even when the device is not properly configured, e.g., because the diagnostic tests may be performed by hardware (e.g., dedicated hardware, such as the embedded controller) of the electronic device. More specifically, the hardware, e.g., the embedded controller, may only require power to operate fully and perform the functions described herein. Thus, in some embodiments, the diagnostic tests may be performed in response to input.

In alternate embodiments, the diagnostic tests may be performed automatically, i.e., without requiring any input from a user or, in some cases, from anywhere else. For example, in one embodiment, the diagnostic tests may be running constantly or according to time intervals after initiation of the electronic device. As a more specific example, the diagnostic tests may execute once every ten minutes upon powering up, among other times and intervals. Alternatively, or additionally, the diagnostic tests may be executing all the time, e.g., as monitoring processes, which may allow the electronic device to quickly react to problems as they happen.

Additionally, one or more problems may be identified with regard to the operation of the electronic device based on the one or more diagnostic tests. In some embodiments, the diagnostic tests may provide error codes which may then be used to identify the problems. For example, when no processor is detected for an electronic system, the diagnostic tests may produce an error code that may be used to find the problem(s) in a look-up table or database stored in the electronic device, e.g., in a memory medium which may be coupled to or included in the embedded controller. Alternatively, or additionally, the problem may be identified based on failure point in the diagnostic test sequence.

The identified problems may be any of various problems. For example, the problem(s) may be configuration problems, e.g., where the user may have incorrectly connected various components/parts of the electronic system. As a specific configuration problem, the user may have coupled a keyboard to a mouse port of a computer system. In this case, the diagnostic test may return an error code associated with the input/output devices which indicates a particular keyboard problem. Thus, the problems may be identified simply, e.g., through simple look-ups of error codes, or intelligently, e.g., through correlations of the results of the diagnostic tests.

Other types of problems may be identified as well. For example, the diagnostic tests may discover that the hard drive, e.g., of the computer system, is not responding, or that an error code occurred with respect to the hard drive. In such cases, the identified problem may include a hard drive malfunction, e.g., malfunctioning hard drive magnets, or, as another example, that the direct memory access (DMA) of the hard drive failed, among other types of component failures. Thus, component errors or malfunctions may be identified based on the one or more diagnostic tests, e.g., from error codes generated by the diagnostic tests or from the diagnostic tests directly. Note that the above methods for identification of the one or more problems are exemplary only and that other identification methods are envisioned. Thus, a wide variety of problems may be identified according to the diagnostic tests.

One or more speech phrases which indicate the one or more problems may be audibly presented to the user. The speech phrase(s) may be presented based on the identified one or more problems; however, in some embodiments, the speech phrase may be presented after failure of a diagnostic test. In other words, if a diagnostic test fails, the speech phrases may be audibly presented to indicate the failed test/problem to the user.

More specifically, the speech phrases may be presented from a memory location, e.g., of a memory medium coupled to the embedded controller. For example, in some embodiments, the identified problems (or diagnostic tests) may provide some kind of signal or code which may be used to look up the proper speech phrase to be presented to the user. In one embodiment, the speech phrases may be stored in non-volatile memory, e.g., flash memory, and may be played back to the user when appropriate, e.g., following the descriptions herein. Alternatively, or additionally, the codes may be used to look up text phrases in a database, e.g., stored in the memory medium above or another memory medium coupled to the hardware used to present the speech phrases. These phrases may be audibly presented to the user using text-to-speech synthesis.

The one or more speech phrases may indicate to the user how to solve the problem and/or additional resources which may be used to solve the problem. For example, the user may have incorrectly plugged in a speaker connection (e.g., an eighth inch speaker jack) into the microphone port of an electronic device, e.g., a computer system. Correspondingly, the electronic device may identify the problem and present one or more speech phrases to the user which indicates the configuration problem and instructs the user on how to solve the problem. More specifically, the electronic device might “speak” to the user by presenting the speech phrases: “The speakers are plugged into the microphone port of the computer. To solve this problem, unplug the speakers from the microphone port and plug them into the green port to the left of the microphone port”. Thus, in some embodiments, the one or more speech phrases may indicate the problem as well as indicate a solution to the problem.

Alternatively, as indicated above, the speech phrases may give the user information leading to additional resources which may be used to solve the problem(s). For example, the speech phrases may inform the user of a website or other contact information which may be used to solve the problem. In one embodiment, the speech phrases may also identify an error code or other information which may indicate the problem for a technical support person who may then use that information to identify a solution for the user.

The method may also include selecting a tutorial from one or more tutorials based on the identified problems. The tutorial may include a first plurality of ordered speech phrases for guiding the user in configuring at least a portion of the electronic device. Selecting the tutorial from the one or more tutorials may include analyzing the one or more problems, determining whether a tutorial should be presented based on the analysis, and then selecting an appropriate tutorial. For example, the electronic device, e.g., the controller included in the electronic device, may determine that the electronic device has never worked in the past, and based on the one or more problems, is not currently working. In this example, it may be appropriate to audibly present speech phrases guiding the user through a basic installation of the electronic device. Similarly, if the device has not been turned on and is not properly operable, a tutorial may be presented to the user. In one embodiment, if there are too many problems, e.g., configuration problems, the electronic device may present a tutorial to the user. For example, if the problems indicate that the majority of the device is not properly configured, it may be better to start from scratch for the user rather than trying to fix all of the problems in the current configuration. Thus, a tutorial may be selected based on the history of the electronic device and/or the current state of the configuration, e.g., the identified problems of the electronic device.

Correspondingly, following the descriptions above, audibly presenting the one or more speech phrases may include audibly presenting the plurality of speech phrases of the tutorial to instruct the user on how to set up the electronic device. Thus, the electronic device may tell the user in plain language, e.g., using recorded or synthesized speech phrases, how to set up the electronic device and/or how to fix the problems in operation of the electronic device.

In addition, the method may also include presenting speech phrases that indicate the status of the electronic device or components of the electronic device. For example, where the electronic device is a computer system, the method (e.g., the controller in the electronic device) present audible speech phrases which indicate the status of the network connection (e.g., “The network cable is unplugged”) or the status of the hard drive or battery (e.g., “Your battery is nearing depletion”). Thus, the controller may also present speech phrases that inform the user of the status of the electronic device as desired.

### BRIEF DESCRIPTION OF THE DRAWINGS

A better understanding of the present invention can be obtained when the following detailed description of the preferred embodiment is considered in conjunction with the following drawings, in which:

FIGS. 1 and 2 illustrate exemplary systems suitable for implementing various embodiments of the invention;

FIG. 3 is a high level block diagram of an exemplary computer system which may implement various embodiments;

FIG. 4 is a high level block diagram of an exemplary electronic system which may implement various embodiments;

FIG. 5 is a flowchart diagram illustrating one embodiment of a method for providing information to a user regarding an electronic system; and

FIGS. 6 and 7 are flowchart diagrams illustrating one embodiment of a series of diagnostic tests.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a physical communication medium such as a bus, network and/or other physical transmission medium.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

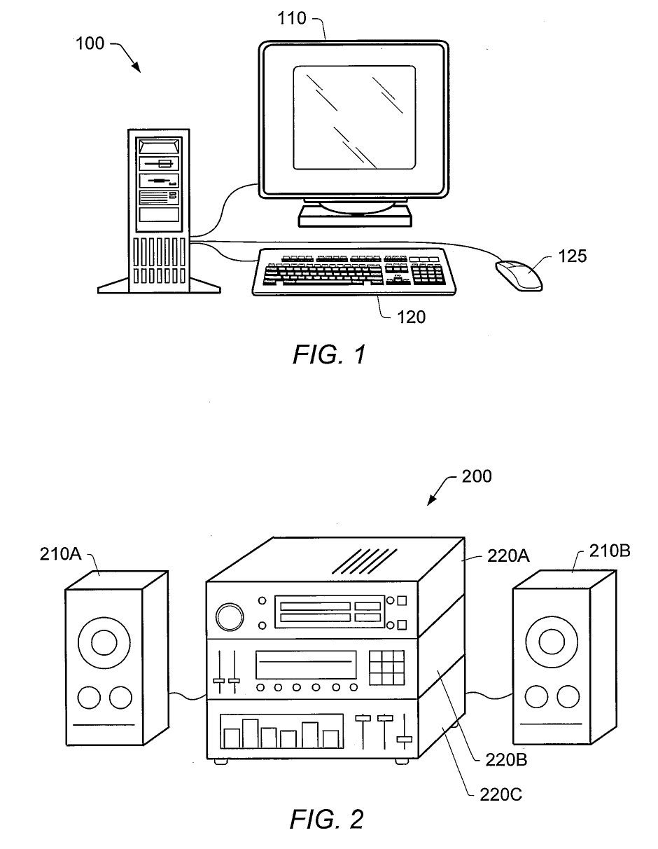

### FIG. 1—Exemplary Computer System

FIG. 1 illustrates a computer system 100 operable to provide information about the computer system to the user.

As shown in FIG. 1, the computer system 100 may include a display device 110 operable to display video signals received from the computer system 100. In some embodiments, the video signals received from the computer system 100 may include those produced by hardware devices of the computer system 100, e.g., during initiation or boot up of the computer system 100 (among other times or processes). Alternatively, or additionally, the video signals may be produced by programs executing on the computer system 100, e.g., operating system software or other software programs. As shown, the computer system 100 may also include various input devices for receiving input, e.g., keyboard 120 and mouse 125.

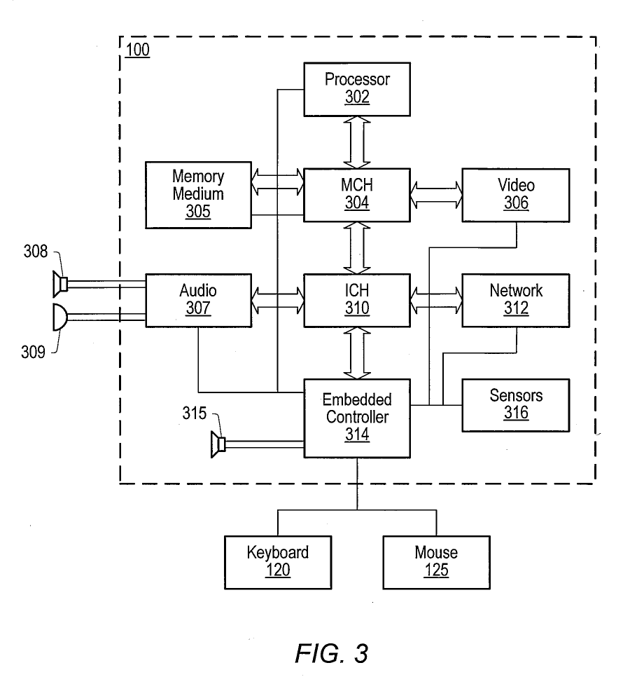

Turning to FIG. 3, in more detail, the computer system 100 may include various hardware components; however, it should be noted that various components may be added or omitted, e.g., to or from those components shown in FIG. 3. As shown, the computer system 100 may include a processor 302, which may be coupled to a memory controller hub (MCH) 304. In some embodiments, the MCH 304 may include or implement the functions of a north bridge of the computer system 100. The computer system 100 may also include at least one memory medium 305, e.g., coupled to the MCH 304, on which one or more computer programs or software components may be stored. As indicated above, the memory medium 305 may also store operating system software, as well as other software for operation of the computer system 100. The processor 302 may execute various ones of the computer programs stored in the memory medium 305 or handled by the MCH 304. In some embodiments, the MCH 304 may be coupled to video 306, e.g., an accelerated graphics port (AGP) video device, a peripheral component interface (PCI) video device, or other video device, operable to provide video output for the computer system 100, e.g., to be displayed on the display 110. Thus, the MCH 304 may provide communications between the processor 302, the memory medium 305, and/or the video 306, among other components on included in the computer 100.

The MCH 304 may also be coupled to input/output (I/O) controller hub (ICH) 310 included in the computer system 100 as illustrated in FIG. 3. Similar to above, the ICH 310 may include or implement the functions of a south bridge of the computer system 100. Additionally, or alternatively, the MCH 304 and the ICH 310 may be included in a single controller hub coupled to the various components shown in FIG. 3, among others. As shown, the ICH 310 may be coupled to may be coupled to audio 307, e.g., an audio card, e.g., a PCI audio card, or the audio 307 may be a built-in audio processor included in the motherboard. The audio 307 may include an audio output 308 for transmitting audio signals and an audio input 309 for receiving audio signals, e.g., for recording. The ICH 310 may also be coupled to network 312 which may provide a network interface for the computer system 100, e.g., to couple to a local area network (LAN) or a wide area network (WAN) such as, for example, the Internet. Thus, the ICH 310 may provide various communications between the MCH 304 and various input/output (I/O) devices/interfaces, e.g., the network 312, the audio 307, the keyboard 120, and the mouse 125 (connectivity described below), among others.

As shown, the ICH 310 may also be coupled to an embedded controller 314 which may implement various embodiments of the invention. The embedded controller 314 may be an individual component included in the computer system 100, e.g., on the motherboard of the computer system 100. In some embodiments, the embedded controller 314 may include a memory medium, e.g., random access memory or nonvolatile memory, and a processor to perform functions or embodiments of the invention. However, in one embodiment, the embedded controller 314 may be a distributed device within the computer system 100, e.g., where processing is spread over several processors in the computer system 100. Alternatively, the embedded controller may be simply coupled to the various components of the computer system 100 or just to the computer system 100. In some embodiments, the embedded controller may be included in the ICH 310 or any other processing unit within 100, e.g., the network 312, video 306 or audio 307 devices, e.g., based on which devices are powered up first or always powered. Thus, according to various embodiments, the embedded controller may be an individual component or a distributed component which may be included in or coupled to the computer system 100, as desired.

Note that the embedded controller 314 described herein may take on any of various connections or forms, and is not limited to the above descriptions. For example, in one embodiment, the embedded controller 314 may not be an “embedded” controller, but may simply be a controller that couples to the components included in or coupled to the computer system 100. Thus, the embedded controller 314 may be any type of appropriate controller.

The embedded controller 314 may include an audio output 315, e.g., an audio transducer, among other types of audio outputs, operable to output various audio signals produced by the embedded controller 314. For example, the audio output 315 may be any type of audio output that allows the embedded controller 314, and/or computer system 100 (or other electronic device) to convey information about the electronic system to the user. In one embodiment, the audio transducer may be a simple speaker which may be operated using power drawn from the computer system 100. However, it should be noted that the audio output 315 may be any type of suitable audio output, and is not limited to the above descriptions. The audio output 315 may be operable to convey information to the user about the computer system 100, e.g., using speech phrases. More specifically, the audio output 315 may be operable even when the rest of the computer system 100 is not operable. Thus, in some embodiments, the embedded controller 314 may be able to provide information to the user without the computer system 100 completely functioning.

The embedded controller 314 may couple to and/or provide an interface between the keyboard 120 and the mouse 125 and the ICH 310. Additionally, as shown, the embedded controller 314 may be coupled to a subset or all of the components in the computer system 100. For example, the embedded controller 314 may couple to the audio 307, the ICH 310, the network 312, the video 306, the MCH 304, the processor 302, the keyboard 120, the mouse 125, and sensors 316. The sensors 316 may be operable to provide various alerts or indications regarding operation of the computer system 100, e.g., to the embedded controller 314 and/or the user. Alternatively, or additionally, the sensors 316 may provide a means for input for the user; for example, in one embodiment, the sensors 316 may be buttons which allow the user to invoke various functionality of the computer system 100. The sensors 316 may also include connection detection. For example, current audio ports may often include sensing circuitry that allow for detection of devices plugged into the port by sensing impedance of the device. Additionally, in some embodiments, the sensors could also include environmental sensors, e.g., for temperature monitoring or accelerometers, e.g., to determine whether the electronic device is experiencing acceleration, e.g., while falling.

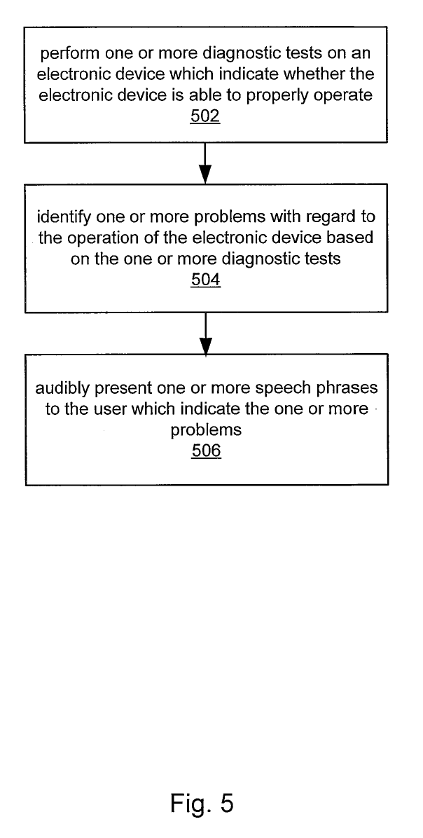

In some embodiments, the embedded controller 314 may perform various functions for the computer system 100, e.g., such as those which may be invoked by the sensors 316. For example, the embedded controller 314 may control various components of the computer system 100 (e.g., a subset or all of the components). Alternatively, or additionally, the embedded controller 314 may perform various initialization and/or diagnostic tests to analyze the computer system 100. Further details regarding functionality of the embedded controller 314 will be described below with regard to FIGS. 5-7. Thus, according to various embodiments, the computer system 100 may include the embedded controller 314 which may perform various functions and/or convey information to the user about the electronic device, in this case, the computer system 100.

Thus, in some embodiments, the computer system may include various components, e.g., the processor 302, the memory medium 305, the MCH 304, etc. Additionally, the computer system may include further components; for example, the computer system may also include hard disk drives, optical disc drives (e.g., compact disc (CD) drives, digital video disc (DVD) drives, BlueRay™ drives, etc.), other memory mediums (e.g., flash memory, other non-volatile memory, and/or static memory, among others), universal serial bus (USB) components (e.g., ports, hubs, controllers, etc.), other cards (e.g., CardBus, ExpressCard, CableCard, etc.), television (TV) tuners, audio amplifiers, security subsystems (e.g., trusted platform modules and/or smart card readers, among others), biometric sensors (e.g., for fingerprints, retinas, voice recognition, etc.), remote control devices (e.g., transmitters and/or receivers), networking subsystems (wired and/or wireless), human interface devices (e.g., the keyboard and mouse described above, touch pads, game controllers, joysticks, etc.), and/or other components, e.g., docking units for portable computers).

### FIG. 2—Exemplary Electronic System

FIG. 2 illustrates an exemplary electronic system 200 operable to convey information about the electronic system to the user. More specifically, the electronic system 200 illustrates a particular stereo system with speakers 210 (speakers 210A and 210B). It should be noted that the electronic system 200 is not limited to the stereo system illustrated in FIG. 2. In particular, the electronic system 200 may include any of various types of electronic systems, e.g., computer systems such as the computer system 100 illustrated in FIG. 1, among others, audio/video systems, gaming systems, handheld systems, testing systems, networking systems, appliances, and/or other electronic systems (e.g., consumer electronic systems).

As shown in FIG. 2, the electronic system 200 may include various parts or components, e.g., the speakers 210, and other devices 220A, 220B, and 220C. In some embodiments, the electronic system may be a complex system, such as, for example, the one illustrated in FIG. 2, e.g., including several devices/parts; however, in alternate embodiments, the electronic system 200 may be a simple single device system, e.g., where all of the electronics are included in a single housing. Thus, the electronic system 200 may include any of various electronic devices, e.g., complex or simple electronic devices.

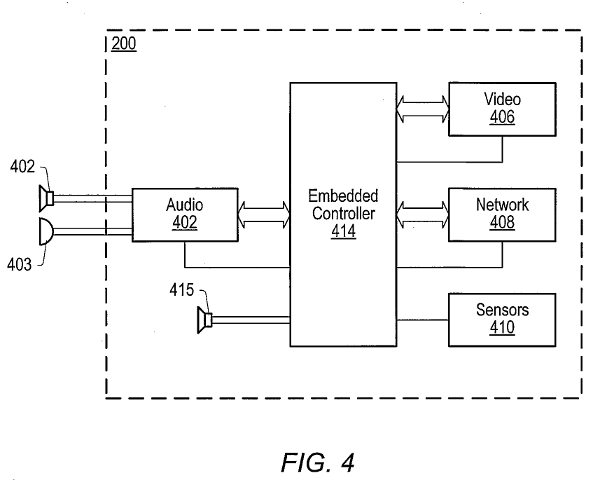

FIG. 4 illustrates an exemplary block diagram of a portion of the electronic system 200, such as, for example, one of the individual electronic devices 220A, 220B, or 220C. As shown, the electronic system 200 may include an embedded controller 414, similar to the embedded controller 314. As described above with respect to the embedded controller 314, the embedded controller 414 may be a distributed or isolated controller, as desired, and may provide information to the user regarding the electronic device 200. As indicated above, the embedded controller 414 may be operable to perform various functions of the electronic system 200, e.g., initialization/diagnostic tests, or control functionality of the electronic system 200. For example, if the electronic device 200 is a receiver for a sound system, the embedded controller 414 may provide the amplification and sound processing functionality that the receiver is designed for. Thus, the embedded controller 414 may perform various functions of the electronic system 200.

As shown, the embedded controller 414 may include an audio output 415 similar to the audio output 315 of the embedded controller 314. Similar to above, the audio output 415 may be operable to convey information to the user about the electronic system 200, e.g., using speech phrases. Similar to above, the audio output 415 may be operable even when the rest of the electronic device 200 is not operable. Thus, in some embodiments, the embedded controller 414 may be able to provide information to the user without the electronic device 200 completely functioning.

Additionally, the embedded controller 414 may be coupled to audio 401, similar to the audio 307, which may send and receive audio input and output via audio input 403 and output 402. As also shown, the embedded controller 414 may be coupled to video 406, e.g., for providing a video output for the electronic system 200, network 408, for providing a network interface for the electronic system 200, and/or sensors 410, similar to the sensors 316 described above with respect to the computer system 100. Similar to the above descriptions of the computer system 100, the various components of the electronic system 200 may be added or omitted as desired. For example, in one embodiment, the electronic system 200 may not have the video 406 or the network 408. Additionally, or alternatively, the electronic system 200 may include other components, e.g., controlling hubs for receiving inputs from various other devices.

Thus, according to various embodiments, the electronic system 200 may include or omit components as desired and may be any of numerous possible electronic devices, such as those described above, among others. For example, the electronic system may include further components, e.g., hard disk drives, optical disc drives (e.g., compact disc (CD) drives, digital video disc (DVD) drives, BlueRay™ drives, etc.), other memory mediums (e.g., flash memory, other non-volatile memory, and/or static memory, among others), universal serial bus (USB) components (e.g., ports, hubs, controllers, etc.), other cards (e.g., CardBus, ExpressCard, CableCard, etc.), television (TV) tuners, audio amplifiers, security subsystems (e.g., trusted platform modules and/or smart card readers, among others), biometric sensors (e.g., for fingerprints, retinas, voice recognition, etc.), remote control devices (e.g., transmitters and/or receivers), networking subsystems (wired and/or wireless), human interface devices (e.g., the keyboard and mouse described above, touch pads, game controllers, joysticks, etc.), and/or other components, e.g., docking units for portable computers).

### FIG. 5—Method for Providing Information to a User Regarding an Electronic System

FIG. 5 is a flowchart which illustrates a method for providing information to a user regarding an electronic system. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 502, one or more diagnostic tests may be performed on an electronic device, e.g., using hardware, e.g., dedicated hardware, of the electronic device. For example, in one embodiment, the diagnostic tests may be performed by a controller in the electronic device, such as the embedded controllers in the electronic systems described above, among others. As also indicated above, the electronic device may be any of various appropriate electronic devices as desired. In one embodiment, the one or more diagnostic tests may indicate whether the electronic device is able to properly operate. For example, the diagnostic tests may check whether each of the components and/or parts of the electronic device is properly functioning, e.g., whether or not there is component failure. More specifically, the diagnostic tests may test each of the components of the electronic device, e.g., by providing stimulus response signals and checking for the appropriate response. As indicated above, in some embodiments, the embedded controller may perform various diagnostic tests on a subset or all of the components in the electronic device.

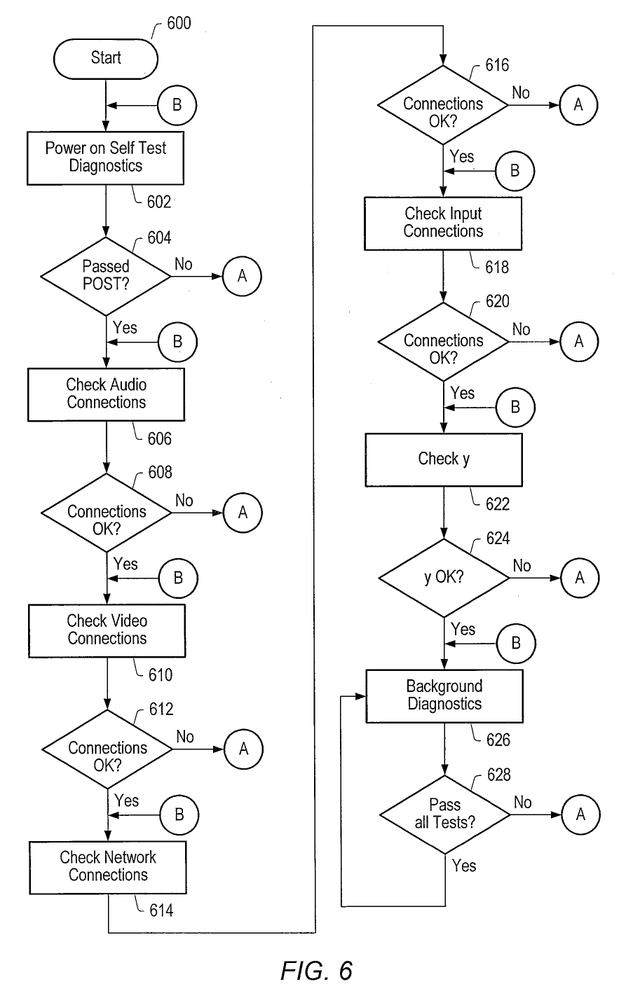

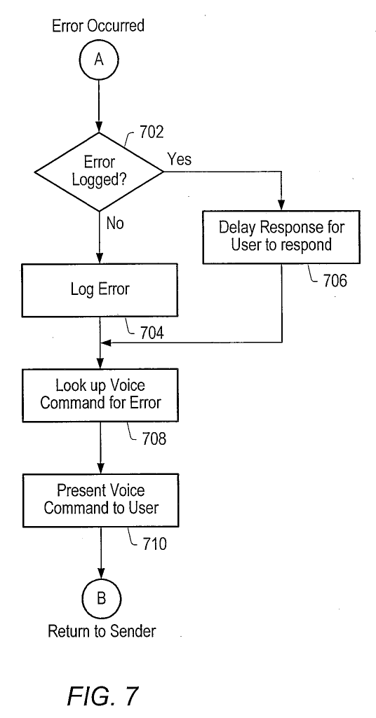

Additionally (or alternatively), the diagnostic tests may determine whether the user has properly configured the device, e.g., whether each of the user-configurable components or parts are properly connected or otherwise configured. For example, the diagnostic tests may determine whether various parts have been attached to the electronic device as required. More specifically, if the electronic device is an audio device, the diagnostic tests may determine whether or not various audio inputs or outputs are connected to the system, e.g., whether the speakers, another audio device (e.g., for providing input or output to the audio device), and other components/parts of the system are coupled to the electronic device. Alternatively, where the electronic device is a computer, the diagnostic tests may determine whether the keyboard and/or the mouse (among other devices) are coupled to the appropriate ports of the computer. Thus, following the descriptions above, the diagnostic tests may determine whether the electronic system should function properly for the user, e.g., by determining if all of the components are functioning properly and whether the electronic device has been properly configured, among others. An exemplary set of diagnostic tests for initiation of a computer system is described in more detail with regard to FIGS. 6 and 7.

In some embodiments, the one or more diagnostic tests may be performed upon initiation or power up of the device; alternatively, or additionally, the electronic system may receive input, e.g., from the user, to initiate the diagnostic tests. Thus, the user may wish to check to make sure if the electronic device is properly functioning (or to properly identify the problem) and may initiate the set of tests or turn on the device, among other initiation methods.

The user may initiate the tests via a variety of methods. For example, in one embodiment, the user may simply press a button or use some kind of menu system, e.g., on a menu of the electronic device, e.g., on the LCD of the electronic device or an external monitor, among others. Note that the user may instruct the electronic device to begin the diagnostic tests in any suitable manner; for example, the user may simply be able to speak to the electronic device and have the electronic device begin the tests, e.g., via voice recognition software/hardware.

However, in some embodiments, the initiation of the diagnostic tests may be simple, such that whatever implemented means for initiation may be invoked when the electronic device is substantially inoperable. Said another way, the tests may be run even when the device is not properly configured, e.g., because the diagnostic tests may be performed by hardware (e.g., dedicated hardware, such as the embedded controller) of the electronic device. More specifically, the hardware, e.g., the embedded controller, may only require power to operate fully and perform the functions described herein. Thus, in some embodiments, the diagnostic tests may be performed in response to user input.

In alternate embodiments, the diagnostic tests may be performed automatically, i.e., without requiring any input from a user or, in some cases, from anywhere else. For example, in one embodiment, the diagnostic tests may be running constantly or according to time intervals after initiation of the electronic device. As a more specific example, the diagnostic tests may execute once every ten minutes upon powering up, among other times and intervals. Alternatively, or additionally, the diagnostic tests may be executing all the time, e.g., as monitoring processes, which may allow the electronic device to quickly react to problems as they happen. Such embodiments may be especially useful while the user is setting up the electronic device or when the diagnostic tests lead to identification of problems which may put the user in a potentially hazardous situation, e.g., if the electronic device is about to start a fire due to an electronic issue or if the user is attempting to fix the device while its power is on.

In 504, one or more problems may be identified with regard to the operation of the electronic device based on the one or more diagnostic tests. In some embodiments, the diagnostic tests may provide error codes which may then be used to identify the problems. For example, when no processor is detected for an electronic system, the diagnostic tests may produce an error code that may be used to find the problem(s) in a look-up table or database stored in the electronic device, e.g., in a memory medium which may be coupled to or included in the embedded controller. Alternatively, or additionally, the problem may be identified based on failure point in the diagnostic test sequence. For example, if the diagnostic tests failed at a point where the processor should have been detected, the problem may be correspondingly identified as, for example, a dysfunctional or missing processor. Note that other the detection methods above are not intended to limit the descriptions here, and that other detection methods are envisioned.

The identified problems may be any of various problems. For example, the problem(s) may be configuration problems, e.g., where the user may have incorrectly connected various components/parts of the electronic system. As a specific configuration problem, the user may have coupled a keyboard to a mouse port of a computer system. In this case, the diagnostic test may return an error code associated with the input/output devices which indicates a particular keyboard problem. More specifically, the indicated particular keyboard problem may report that the keyboard was not plugged in, or that the keyboard was incorrectly plugged into the mouse port of the computer. In some embodiments, the problems may be identified intelligently. For example, following the example above, the diagnostic tests may have returned error codes (or failed in certain locations) that resulted from a missing keyboard and an incorrect response from the mouse port. Correspondingly, the embedded controller (or other hardware) may determine that the keyboard was actually incorrectly plugged into the mouse port of the computer. Thus, the problems may be identified simply, e.g., through simple look-ups of error codes, or intelligently, e.g., through correlations of the results of the diagnostic tests.

Other types of problems may be identified as well. For example, the diagnostic tests may discover that the hard drive, e.g., of the computer system, is not responding, or that an error code occurred with respect to the hard drive. In such cases, the identified problem may include a hard drive malfunction, e.g., malfunctioning hard drive magnets, or, as another example, that the direct memory access (DMA) of the hard drive failed, among other types of component failures. Thus, component errors or malfunctions may be identified based on the one or more diagnostic tests, e.g., from error codes generated by the diagnostic tests or from the diagnostic tests directly. Note that the above methods for identification of the one or more problems are exemplary only and that other identification methods are envisioned. Thus, a wide variety of problems may be identified according to the diagnostic tests. Other exemplary problems and corresponding results will be described below.

In 506, one or more speech phrases which indicate the one or more problems may be audibly presented to the user. The speech phrase(s) may be presented based on the identified one or more problems; however, in some embodiments, the speech phrase may be presented after failure of a diagnostic test. In other words, if a diagnostic test fails, the speech phrases may be audibly presented to indicate the failed test/problem to the user.

More specifically, the speech phrases may be presented from a memory location, e.g., of a memory medium coupled to the embedded controller. For example, in some embodiments, the identified problems (or diagnostic tests) may provide some kind of signal or code which may be used to look up the proper speech phrase to be presented to the user. In one embodiment, the speech phrases may be stored in non-volatile memory, e.g., flash memory, and may be played back to the user when appropriate, e.g., following the descriptions herein. Alternatively, or additionally, the codes may be used to look up text phrases in a database, e.g., stored in the memory medium above or another memory medium coupled to the hardware used to present the speech phrases. These phrases may be audibly presented to the user using text-to-speech synthesis. It should be noted that the above descriptions are exemplary only, and that other methods for identifying the appropriate speech phrases and presenting them are envisioned. For example, the speech phrases may be stored on another electronic component, and may be retrieved and played back as desired. In some embodiments, the method may include playing back speech phrases stored on the component that failed the configuration or diagnostic test if possible, e.g., to provide more specific speech phrases. Thus, the speech phrases may be audibly presented in response to the identified problem or when a diagnostic test fails, among other cases.

In some embodiments, the one or more speech phrases may indicate to the user how to solve the problem and/or additional resources which may be used to solve the problem. For example, the user may have incorrectly plugged in a speaker connection (e.g., an eighth inch speaker jack) into the microphone port of an electronic device, e.g., a computer system. Correspondingly, the electronic device may identify the problem and present one or more speech phrases to the user which indicates the configuration problem and instructs the user on how to solve the problem. More specifically, the electronic device might “speak” to the user by presenting the speech phrases: “The speakers are plugged into the microphone port of the computer. To solve this problem, unplug the speakers from the microphone port and plug them into the green port to the left of the microphone port”. Thus, in some embodiments, the one or more speech phrases may indicate the problem as well as indicate a solution to the problem. Although, in one embodiment, the electronic device may be operable to fix the problem itself. For example, following the example above, the electronic device may be operable to simply switch the microphone and speaker ports to solve the identified problem. Thus, the method may also solve the identified problems with or without alerting the user of the problem.

Alternatively, as indicated above, the speech phrases may give the user information leading to additional resources which may be used to solve the problem(s). For example, the speech phrases may inform the user of a website or other contact information which may be used to solve the problem. In one embodiment, the speech phrases may also identify an error code or other information which may indicate the problem for a technical support person who may then use that information to identify a solution for the user.

In some embodiments, the speech phrases may vary in complexity, e.g., according to settings. For example, in one embodiment, the speech phrases may be simple, e.g., directed towards more common users. Alternatively, or additionally, the speech phrases may be more complex, e.g., for a technical user or for a technician of the electronic device. In one embodiment, the user may be able to specify what complexity the speech phrases are presented in. For example, the speech phrases may be by default simple, but through via various mechanisms the user may be able to enable or turn on the more complex speech phrases, e.g., using the various input methods described herein (e.g., using various menus, remote controls, voice commands, input devices, buttons, sensors, etc.), among others. Thus, the one or more speech phrases may vary in complexity.

In one embodiment, the method may also include selecting a tutorial from one or more tutorials based on the identified problems. The tutorial may include a first plurality of ordered speech phrases for guiding the user in configuring at least a portion of the electronic device. Selecting the tutorial from the one or more tutorials may include analyzing the one or more problems, determining whether a tutorial should be presented based on the analysis, and then selecting an appropriate tutorial. For example, the electronic device, e.g., the controller included in the electronic device, may determine that the electronic device has never worked in the past, and based on the one or more problems, is not currently working. In this example, it may be appropriate to audibly present speech phrases guiding the user through a basic installation of the electronic device. Similarly, if the device has not been turned on and is not properly operable, a tutorial may be presented to the user. In one embodiment, if there are too many problems, e.g., configuration problems, the electronic device may present a tutorial to the user. For example, if the problems indicate that the majority of the device is not properly configured, it may be better to start from scratch for the user rather than trying to fix all of the problems in the current configuration. Thus, a tutorial may be selected based on the history of the electronic device and/or the current state of the configuration, e.g., the identified problems of the electronic device.

Correspondingly, following the descriptions above, audibly presenting the one or more speech phrases may include audibly presenting the plurality of speech phrases of the tutorial to instruct the user on how to set up the electronic device. Thus, the electronic device may tell the user in plain language, e.g., using recorded or synthesized speech phrases, how to set up the electronic device and/or how to fix the problems in operation of the electronic device.

In some embodiments, the method may also include presenting speech phrases that indicate the status of the electronic device or components of the electronic device. For example, where the electronic device is a computer system, the method (e.g., the controller in the electronic device) present audible speech phrases which indicate the status of the network connection (e.g., “The network cable is unplugged”) or the status of the hard drive or battery (e.g., “Your battery is nearing depletion”). Thus, the controller may also present speech phrases that inform the user of the status of the electronic device as desired.

It should be noted that the speech phrases described herein may be presented in a plurality of languages. In some embodiments, the user may be able to configure which language the speech phrases are presented in, e.g., using various input methods described herein, among others. Alternatively, or additionally, the electronic device(s) may be shipped with a default language, e.g., as a configured-to-order option, whereby the electronic device presents the speech phrases (“speaks”) in the default or specified language. Thus, in various embodiments, the speech phrases may be audibly presented in multiple languages, e.g., by specification or by default.

### Exemplary Problems and Resulting Speech Phrases

Following the systems and methods above, described herein are exemplary problems and resulting speech phrases which may describe the problem to the user. In embodiments where the electronic device includes audio components, the speech phrase “No audio connections detected, please check cables” may be audibly presented when the user has not plugged in any audio connections. Similarly, when the user fails to plug in the video, “No video connections detected, please check cables” may be presented. Similar phrases may be applied for keyboard connections, mouse connections, game port connections, network connections, and any other type of appropriate connection, as desired. In one embodiment, the user may be installing or using an electronic system that requires to inputs, e.g., for a two player game on a gaming device; in such cases, the gaming system may tell the user, “Only one game controller is connected, please check cables” or similar phrases.

Additional phrases include “Printer power is not turned on”, “Video resolution is 480p”, “Video resolution is 720p”, “Video resolution is 1080i”, “Hard drive is reporting problems, please contact service”, “No CD or DVD is detected, please contact service”, “Hard drive is full”, “Flash card is full”, “Network speed is too low for quality video”, “This video format not supported”, “This audio format not supported”, “This picture format is not supported”, “Disk format is not supported”, “This remote control is not supported”, and “Call service and tell them error code X” (where X is the actual error code), among other speech phrases. Note that the above speech phrases and problems are exemplary only and that further speech phrases and problems are envisioned. Additionally, many of the phrases above may be equally applied to other scenarios, e.g., the phrase “Printer power is not turned on” may equally apply to a router, digital camera, or other device, e.g., “Power for component X is not turned on” (where X is the actual component). Thus, various problems and corresponding speech phrases may be detected and audibly presented to the user as desired.

### Method for Presenting a Tutorial to the User

The following describes a method for providing information to a user regarding an electronic system. The method may be used in conjunction with any of the computer systems or devices shown in the above Figures, among other devices. In various embodiments, some of the method elements described may be performed concurrently, in a different order than shown, or may be omitted. Additional method elements may also be performed as desired. As shown, this method may operate as follows.

The electronic device may receive input specifying initiation of a tutorial from one or more tutorials. Similar to the above descriptions, the tutorial includes a first plurality of ordered speech phrases, e.g., for guiding a user in configuring at least a portion of the electronic device. Said another way, the tutorial may help the user set up the electronic device (or some portion of the device) from initial parts, e.g., where the device has not been configured. Similar to above, the input may include powering on the electronic device, e.g., when the tutorial is a basic installation tutorial. More specifically, the tutorial may begin when the user turns on the electronic device for the first time. Alternatively, or additionally, the user may be able to invoke the tutorial via various methods, e.g., pressing a “tutorial” button, or accessing the information from a menu, among other methods. In some embodiments, the electronic device may simply detect if it is properly configured, and if it is not, beginning a tutorial from one or more tutorials, e.g., the basic installation tutorial.

Correspondingly, the electronic device may begin audibly presenting the tutorial to guide the user in configuring the portion (or all) of the electronic device. In some embodiments, the hardware of the electronic device may perform all of the functionality of receiving the input from the user and audibly presenting the tutorial. In other words, the tutorial and presenting the tutorial may not be performed by software, e.g., the tutorial may not be a simple user invoked wave or video tutorial, such as one that might be invoked on a computer. Thus, according to one embodiment, the electronic device may include a controller, e.g., the embedded controllers described above, among others, which may receive the input and audibly present the tutorial without the use of software, e.g., on a computer.

In particular, the electronic device may thus be able to instruct the user on how to set up the electronic device without being configured. Thus, the user may easily set up the electronic device by the electronic device instructing the user, e.g., using a human or synthesized voice, in plain language.

### FIGS. 6 and 7—Exemplary Diagnostic Tests

FIGS. 6 and 7 are flowcharts which illustrate an exemplary set of diagnostic tests and methods associated therewith. More particularly, FIGS. 6 and 7 give one specific example of a set of diagnostic tests that may be run upon initiation (or power up) of the electronic device, in this case, a computer system. However, it should be noted that one or more of these diagnostic tests may be performed at various other times, e.g., periodically, or upon input as described above, among other tests and methods. Additionally, the methods shown in FIGS. 6 and 7 may be used in conjunction with any of the computer systems or devices shown in the above Figures, among other devices. In various embodiments, some of the method elements or diagnostic tests shown may be performed concurrently, in a different order than shown, or may be omitted. Additional method elements or diagnostic tests may also be performed as desired. As shown, the exemplary diagnostic operates as follows.

At 600, the diagnostic test may begin. In some embodiments, the diagnostic tests may begin with a power on self test (POST) diagnostics 602. In some embodiments, the POST may include testing of the power supply to ensure that it is turned on and that it releases its reset signal, e.g., in response to the POST. Additionally, the POST may include testing the processor (e.g., the CPU), e.g., making sure that the processor exits the reset status mode and is able to execute instructions, checking whether the BIOS is readable, checking the BIOS checksum validity, e.g., readability, checking the CMOS for reading accessibility, checking the CMOS checksum, checking that the processor can read all forms of memory, e.g., via/from the memory controller, memory bus, and/or memory module, checking that the first 64 kilobytes (kB) is operational, e.g., read/writeable and/or capable of containing POST code, checking accessibility of the ICH (e.g., I/O bus), and/or checking the video subsystem of the ICH, e.g., readability of video RAM, among other tests. Thus, the POST test may include various tests/checks and may be initialized on power up. At 604, a failure check may be performed to see if the POST passed. If it did not, the method may proceed to A, illustrated in FIG. 7.

At 702, a check may be performed to see if the error was logged. If it is already logged, a response may be delayed so that the user may respond at 706. More specifically, the system may provide a delay to allow time to pass for the user to remedy the problem before repeating the error message. This may provide benefits over existing systems in which test beeps repeat continuously until the unit is corrected. Thus, the user may not have to continuously hear a speech phrase, e.g., “Plug in speakers”, but may repeat the speech phrase periodically, or just once, as desired. Alternatively, if the Error should be logged then the error is logged at 704. Proceeding from this point, a voice command may be located, e.g., in the memory of the controller, at 708. Following the descriptions above, the voice command, e.g., speech phrases, may be located in a memory medium, e.g., in a look-up table, database, or other source. At 710, the voice command (e.g., the one or more speech phrases, such as those described above, among others) may be presented to the user, e.g., by playing back the stored voice command or speech phrase or by synthesizing the speech phrases from stored text phrases, similar to descriptions above. Upon reaching B, the diagnostic tests may continue from the B before the current test. In other words, the test that just failed may be run repeatedly until the problem has been fixed, e.g., by the user. Alternatively, in some embodiments, the tests may continue on to the next diagnostic test in the series of tests.

Similar to the descriptions above regarding POST, audio connections may be checked at 606 and 608, video connections may be checked at 610 and 612, network connections may be checked at 614 and 616, and input connections may be checked at 620 and 622. At 622, any of a variety of tests may be performed as represented by “y” in the Figure, such as those problems and connections described above, among others. Upon the initiation tests completing, background diagnostics (e.g., periodic or continuous diagnostics) may begin to execute in 626 and 628, e.g., such as the set of diagnostic tests described above, among others. If any of the tests fail, the procedure of FIG. 7 may be begun similar to descriptions above.

Thus, according to various embodiments, an electronic device may inform a user about an electronic device using speech phrases. As described above, the electronic device may be able to present the speech phrases without being substantially operable. Thus, following various embodiments above where the controller includes an audio output, the speech phrases to solve problems or set up the electronic device may be audibly presented to the user even when the electronic device has not been configured, thereby ameliorating user frustration and lost profits for the manufacturer.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for providing information to a user about an electronic device, the method comprising:
performing one or more diagnostic tests on the electronic device, wherein the one or more diagnostic tests indicate whether the electronic device is able to properly operate;
identifying one or more problems with regard to the operation of the electronic device based on said performing the one or more diagnostic tests; and
audibly presenting one or more speech phrases to the user which indicate the one or more problems.

2. The method of claim 1, wherein the one or more speech phrases indicate how to solve the one or more problems.

3. The method of claim 1, wherein the one or more speech phrases indicate one or more resources usable to solve the one or more problems.

4. The method of claim 1, wherein the one or more problems comprise at least one configuration problem, and wherein said audibly presenting the one or more speech phrases comprises indicating the at least one configuration problem.

5. The method of claim 4, wherein the at least one configuration problem comprises a user generated connectivity problem.

6. The method of claim 1, wherein the one or more problems comprises at least one electronic device malfunction, and wherein said audibly presenting the one or more speech phrases comprises indicating the electronic device malfunction.

7. The method of claim 6, wherein said audibly presenting the one or more speech phrases comprises indicating the specific component of the electronic device that malfunctioned.

8. The method of claim 1, further comprising:
selecting a tutorial from one or more tutorials based on the one or more problems, wherein the tutorial comprises a first plurality of ordered speech phrases for guiding a user in configuring at least a portion of the electronic device; and
audibly presenting the tutorial to guide the user in configuring the at least a portion of the electronic device.

9. The method of claim 8, wherein said selecting the tutorial comprises:
analyzing the one or more problems;
determining if a tutorial should be audibly presented based on said analyzing; and
selecting the tutorial from one or more tutorials based on the one or more problems.

10. The method of claim 9, wherein said determining if the tutorial should be audibly presented comprises one or more of:
determining if the device has properly operated in the past;
determining if the device has been turned on in the past; or
determining if the number of the one or more problems is above a certain threshold.

11. The method of claim 1, wherein said performing the one or more diagnostic tests occurs upon initialization.

12. The method of claim 1, wherein said performing the one or more diagnostic tests is performed:
in response to input; or
automatically, wherein said automatically performing the one or more diagnostic tests requires no input to perform the one or more diagnostic tests.

13. The method of claim 1, wherein the electronic device is a personal computer system.

14. The method of claim 1, the method further comprising:
audibly presenting at least one speech phrase which indicates the status of the electronic device or components thereof.

15. A controller for use in an electronic system, comprising:
a processor;
an audio transducer coupled to the processor; and
a memory medium coupled to the processor which comprises program instructions executable to:
perform one or more diagnostic tests on the electronic system, wherein the one or more diagnostic tests indicate whether the electronic system is able to properly operate;
identify one or more problems with regard to the operation of the electronic device based on the one or more diagnostic tests; and
audibly present one or more speech phrases to the user via the audio transducer, wherein the one or more speech phrases indicates the one or more problems.

16. The controller of claim 15, wherein the one or more speech phrases indicate how to solve the one or more problems.

17. The controller of claim 15, wherein the one or more problems comprise at least one configuration problem, and wherein said audibly presenting the one or more speech phrases comprises indicating the at least one configuration problem.

18. The controller of claim 15, wherein the one or more problems comprises at least one electronic device malfunction, and wherein said audibly presenting the one or more speech phrases comprises indicating the electronic device malfunction.

19. The controller of claim 15, wherein the program instructions are further executable to:
select a tutorial from one or more tutorials based on the one or more problems, wherein the tutorial comprises a first plurality of ordered speech phrases for guiding a user in configuring at least a portion of the electronic device; and
audibly present the tutorial to guide the user in configuring the at least a portion of the electronic device.

20. The controller of claim 15, wherein the one or more diagnostic tests are performed upon initialization.

21. A controller for use in a computer system, comprising:
a processor;
an audio transducer coupled to the processor; and
a memory medium coupled to the processor which comprises program instructions executable to:
perform one or more diagnostic tests on the computer system, wherein the one or more diagnostic tests indicate whether the computer system is able to properly operate;
identify one or more problems of the computer system based on the one or more diagnostic tests; and
audibly present one or more speech phrases to the user via the audio transducer, wherein the one or more speech phrases indicate the one or more problems.

22. A method for providing information to a user about an electronic device, the method comprising:
performing one or more tests on the electronic device, wherein the one or more diagnostic tests indicate whether the electronic device is properly configured;
if a first diagnostic test fails, audibly presenting a speech phrase to the user indicating a problem associated with failure of the first diagnostic test.

23. A method for providing a tutorial to a user for an electronic device, the method comprising:
the electronic device receiving input specifying initiation of a tutorial from one or more tutorials, wherein the tutorial comprises a first plurality of ordered speech phrases for guiding a user in configuring at least a portion of the electronic device; and
the electronic device audibly presenting the tutorial to guide the user in configuring the at least a portion of the electronic device;
wherein said receiving input and said audibly presenting the tutorial are performed by hardware of the electronic device.

24. The method of claim 23, wherein said receiving input specifying initiation comprises powering on the electronic device, and wherein the tutorial is a basic installation tutorial.

25. The method of claim 23, further comprising:
detecting whether the electronic device is properly configured;
wherein said receiving input specifying initiation comprises powering on the electronic device when the device is not properly configured, and wherein the tutorial is a basic installation tutorial.
